(19) United States
(12) Patent Application Publication
(10) Pub. No.: US 2005/0055678 A1
(43) Pub. Date: Mar. 10, 2005

(54) Method and apparatus for managing software in computer system using virtual machine

(76) Inventor: Ryuji Sakai, Hanno-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/926,308

(22) Filed: Aug. 26, 2004

(30) Foreign Application Priority Data
Aug. 28, 2003 (JP) 2003-304780

(51) Int. Cl. G06F 9/45; G06F 9/44

(52) U.S. Cl. 717/136; 717/118

(57) ABSTRACT

There is disclosed a software management system which is applied to a computer system using a virtual machine. The software management system converts an assembly code specialized and generated for an architecture of a designated microprocessor into a virtual machine code, and manages and operates the code as package software in which the virtual machine code and virtual machine description are packaged.

### CROSS-REFERENCE TO RELATED APPLICATIONS

This application is based upon and claims the benefit of priority from the prior Japanese Patent Application No. 2003-304780, filed Aug. 28, 2003, the entire contents of which are incorporated herein by reference.

### BACKGROUND OF THE INVENTION

1. Field of the Invention

The present invention relates generally to a computer system using a virtual machine, particularly to a technique for managing software in a virtual machine code.

2. Description of the Related Art

Computer systems for executing software (e.g., Java program, Java is a registered trademark) which does not depend on hardware of a computer or a platform of an operating system (OS) or the like have heretofore been used in various types of electronic apparatuses.

The software is a computer program operating on a plurality of different instruction set architectures, and is executed by a computer system on which software called a virtual machine (VM) is mounted.

The virtual machine executes a virtual instruction string (virtual machine code) which defines a virtual instruction set architecture and in which a program described in a high-level language (e.g., Java language) is compiled.

For example, in a system having Java virtual machine specifications, a source code described in the Java language is converted into a virtual machine code (Java byte code) which is an execution format program of the virtual machine by a compiler. The software, especially package software, is managed by the virtual machine code, and executed when the virtual machine code is interpreted by the virtual machine. There is also a system for converting the virtual machine code into a machine code which is an execution format code of a specific machine (microprocessor: CPU) to be executed by a just-in-time (JIT) compiler at the time of execution.

Many virtual machines constituted of instruction sets virtualized in this manner have a high degree of abstraction so that various types of architectures can be universally handled. Therefore, an execution efficiency of the software having the virtual machine specifications lowers as compared with software described in an assembly code specialized and developed for a specific CPU architecture especially to pursue an ultimate performance of the computer. Therefore, especially a program requiring a high performance specialized for the hardware is described in the assembly code while versatility is sacrificed in many cases.

Additionally, a system has also been developed in which the program described in the assembly code is translated into a program of another architecture and executed, or instructions are interpreted/executed one by one at the time of execution in order to obtain versatility of the virtual machine (see U.S. Pat. No. 6,021,272 or 5,307,492, for example).

However, in the method described in the prior-art document or the like, for example, even when a program specialized for a single instruction multiple data (SIMD) instruction or the architecture of a special memory hierarchy is simply converted into a program corresponding to the other architecture, advantages of specialty cannot be inherited.

On the other hand, when the architecture is version-upgraded, it is sometimes difficult to efficiently operate an old version of a program in a new version because of the specialty.

### BRIEF SUMMARY OF THE INVENTION

In accordance with one embodiment of the present invention, there is provided a computer system including facilities to manage package software constituted of a virtual machine code to which virtual machine description defining an architecture assumed by a virtual machine has been added.

The system comprises: first storage unit for storing virtual machine description which defines an architecture of a virtual machine; generating unit for generating a virtual machine code from a program which is an execution object; second storage unit for storing software constituted of the virtual machine code to which the virtual machine description has been added; and management unit for taking the software from the second storage unit to execute the software, when the program is executed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a computer system according to an embodiment of the present invention;

FIG. 2 is a diagram showing one example of each description of a target machine and a virtual machine according to the present embodiment;

FIG. 3 is a flowchart showing a processing procedure of a reverse compiler according to the present embodiment;

FIG. 4 is a flowchart showing a procedure at the time of execution of a program according to the present embodiment;

FIG. 5 is a block diagram showing another embodiment; and

FIG. 6 is a flowchart showing an operation of the other embodiment.

### DETAILED DESCRIPTION OF THE INVENTION

Embodiments of the present invention will be described hereinafter with reference to the drawings.

(Constitution of System)

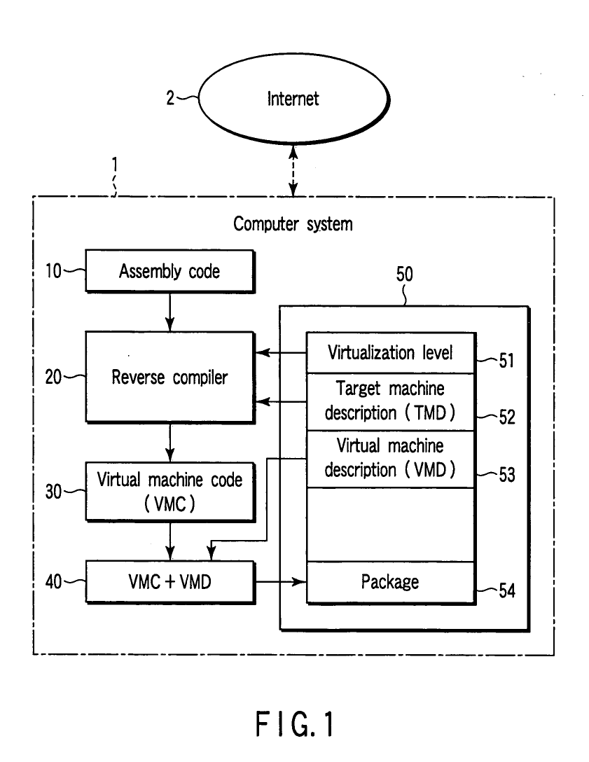

As shown in FIG. 1, a computer system 1 according to the present embodiment includes a reverse compiler 20 which converts an assembly code 10 into a virtual machine code (VMC) 30. The assembly code 10 is a program specialized and designed for a target machine which is a microprocessor (CPU) including a specific architecture, for example, by program development.

The virtual machine code (VMC) 30 corresponds to a Java byte code having, for example, Java virtual machine specifications, and is an execution format program of a virtual machine. The target machine (CPU) converts the virtual machine code (VMC) 30 into a machine code to execute the code at the time of execution.

Furthermore, the present system 1 includes a storage device 50 for managing software. The storage In the storage device 50, virtualization level information 51 necessary for reverse compilation by the reverse compiler 20, target machine description (TMD) 52, virtual machine description (VMD) 53, and package program 54 described later are stored.

Here, the present system 1 is connected to Internet 2, and also executes an operation for supplying the package program 54 being managed in accordance with a request from another computer system.

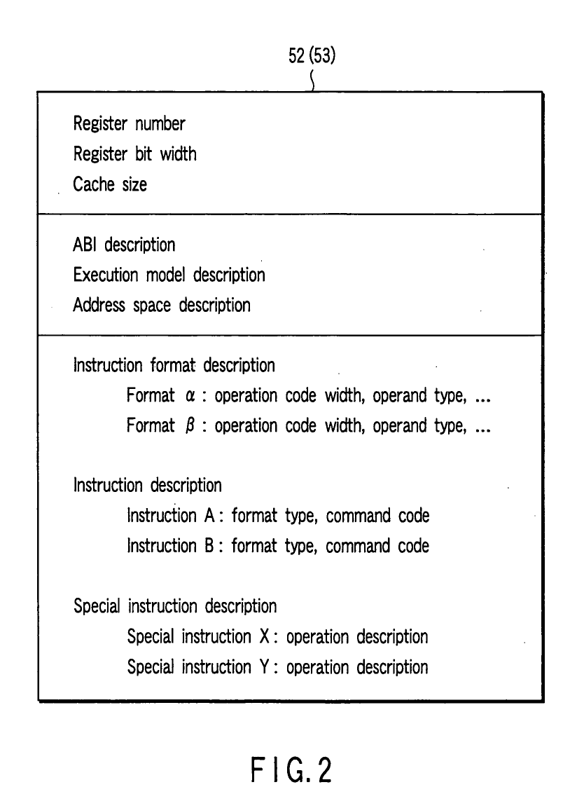

Concretely, as shown in FIG. 2, the TMD 52 and VMD 53 are information in which architectures such as instruction set architectures of a real machine and virtual machine are described. The virtualization level information 51 is information indicating a degree of abstraction (virtualization hierarchy) in a case where a hardware dependent portion of the assembly code 10 that depends on hardware of a designated target machine is abstracted and converted into a virtual machine code.

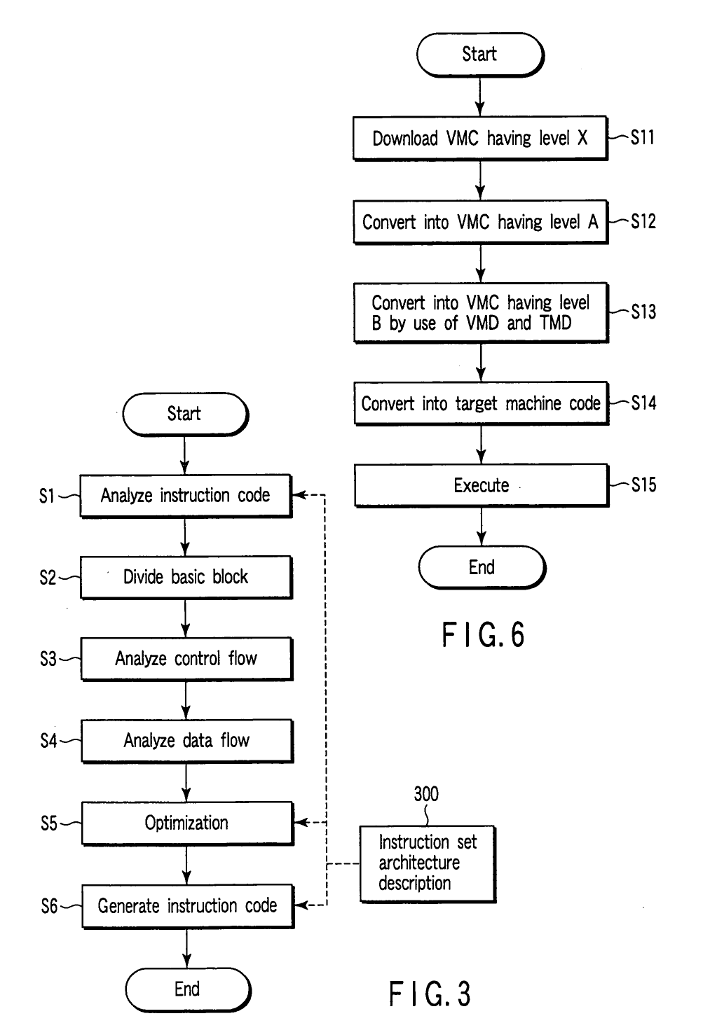

The reverse compiler 20 executes reverse compilation to convert the assembly code 10 into the virtual machine code 30 using the TMD 52 in accordance with a virtualization level by the virtualization level information 51. The reverse compiler 20 executes processing similar to usual reverse compilation as shown in a flowchart of FIG. 3.

It is to be noted that a method of using the TMD 52 is similar to a method of using machine description in processing of a disassembler described, for example, in U.S. Pat. No. 6,021,272 which is a prior-art document.

That is, as shown in FIG. 3, the reverse compiler 20 successively executes analysis of an instruction code (S1), division of a basic block (S2), analysis of a control flow (S3), analysis of a data flow (S4), optimization (S5), and generating of the instruction code (S6). The reverse compiler 20 uses the TMD 52 as instruction set architecture description 300 in each of the analysis of the instruction code (S1), the optimization (S5), and the generating of the instruction code (S6).

Furthermore, the reverse compiler 20 may also retrace the virtualization hierarchy to repeat conversion in accordance with the virtualization level designated based on the designated virtualization level information 51. The reverse compiler 20 may also check dependence of the assembly code 10 on data between instructions, and notify pipeline hazard information or provide another hint for the optimization. When this mechanism is mounted, the assembly code developer can correct the assembly code and efficiently perform tuning in accordance with the hint.

Additionally, in the present system 1, a program 40 in which the designated virtual machine description (VMD) 53 stored in the storage device 50 has been added to the virtual machine code (VMC) 30 generated by the reverse compiler 20 is stored as the package program 54 in the storage device 50.

As described above, the computer system 1 of the present embodiment converts the assembly code 10 specialized and designed for the target machine (CPU) having the specific architecture into the virtual machine code (VMC) 30. Moreover, the present system 1 manages and operates the software by units of the program 40 in which the VMC 30 and the virtual machine description (VMD) 53 are packaged.

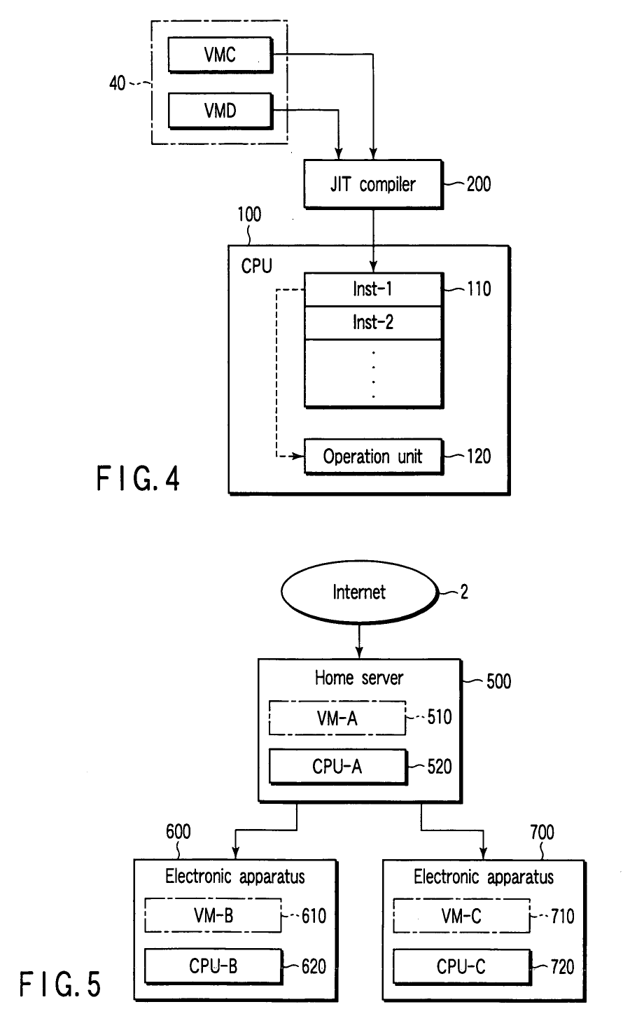

In the present system 1, as shown in FIG. 4, a JIT compiler 200 uses the VMD 53 from the program 40 in which the VMC 30 and the VMD 53 are packaged, and converts the VMC 30 into a machine code 110 of the target machine (CPU 100) at the time of execution of the software. The CPU 100 executes the machine code 110 by an operation unit 120 or the like.

Therefore, the computer system 1 of the present embodiment converts the assembly code 10 specialized and designed for the specific CPU architecture at the time of development of the program into the virtual machine code 30 having a high degree of abstraction (high versatility). That is, the virtual machine code 30 assuming a virtual architecture can cope with various types of architectures.

Furthermore, the computer system 1 of the present embodiment manages the software by the units of the program 40 in which the virtual machine code 30 and the virtual machine description (VMD) 53 are packaged. That is, when the VMD 53 defining various types of virtual architectures is added, it is possible to manage and operate the software in which a special architecture (e.g., SIMD instruction, special memory hierarchy, etc.) included in the software described in the assembly code 10 is reflected.

Therefore, it is possible to improve applicability to the specific architecture together with the versatility, with these virtual machine specifications.

Concretely, when the virtual machine code 30 is converted into the machine code of the target machine having an architecture different from that at the time of the development of the program, the code can be converted into a machine code in which the special architecture at the time of the development is reflected by the VMD 53.

Moreover, even when the architecture at the time of the development of the program is version-upgraded, version-upgraded contents are included into the VMD 53, and it is accordingly possible to efficiently operate an older version of the program in a new version.

In short, according to a software management method of the present embodiment, the assembly code specialized for the specific architecture is managed and operated in a format of the virtual machine code (VMC) abstracted by the reverse compilation.

Moreover, the VMC, the virtual machine description (VMD), and the target machine description (TMD) are separately managed (stored). Therefore, it is possible to improve the applicability to another target machine or the version-upgraded architecture without impairing an execution performance of the program described in the assembly code. As a result, it is possible to reduce management and operation costs of the software.

It is to be noted that it is inefficient in the management to add copies of all information to each package with respect to the virtual machine description (VMD) 53, and therefore a method of adding ID information for identifying the VMD 53 to the VMC 30 to manage the software may also be used.

Furthermore, a program developer or user may also add information such as reservation of a resource which is an environment for operating the program, allocation, topology on network, and cooperation environment as expansion of the VMD 53 if necessary.

Additionally, the computer system 1 of the present embodiment may also include a mechanism for instructing the reverse compiler 20 to maintain a instruction order, register allocation and the like in the assembly code developed by in consideration of the performance of the CPU, so that reversible conversion is executed to return the virtual machine code to the original assembly code at the time of the execution of the program.

(Other Embodiment)

FIGS. 5 and 6 are a block diagram and a flowchart showing another embodiment of a method of managing software.

In the present embodiment, as shown in FIG. 5, a home network (LAN) constituted of a home server 500 connected to Internet 2 and a plurality of electronic apparatuses 600, 700 is assumed. The home server 500 includes a CPU 520 including an architecture (A), and is connected to the plurality of electronic apparatuses 600, 700 via the LAN to exchange data. The respective electronic apparatuses 600, 700 include CPUs 620, 720 with different architectures (B), (C).

A constitution of the present embodiment will be described hereinafter with reference to the flowchart of FIG. 6 together with FIG. 5.

The home server 500 downloads a virtual machine code (VMC having a virtualization level X) which is a desired application program from the internet 2 (step S11).

The home server 500 uses the TMD of the architecture (A), and converts the downloaded VMC having the virtualization level X into the VMC having a virtualization level A which has a relatively low degree of abstraction to store the code (step S12).

The home server 500 executes the VMC having the virtualization level A by a virtual machine (VM-A) 510 having the virtualization level A at the time of the execution of the application program. Accordingly, the CPU 520 executes the machine code converted from the VMC having the virtualization level A to execute the application program.

On the other hand, for example, when the VMC having the virtualization level A is transferred from the home server 500, the electronic apparatus 600 converts the VMC into that having a virtualization level B whose degree of abstraction is even lower to store the code (step S13). At this time, the electronic apparatus 600 converts the VMC into that having the virtualization level B using the virtual machine description (VMD) and the TMD of the architecture (A) corresponding to the virtualization level B.

Moreover, the electronic apparatus 600 executes the VMC having the virtualization level B by a virtual machine (VM-B) 610 having the virtualization level B at the time of the execution of the application program. Accordingly, the CPU 620 executes the machine code converted from the VMC having the virtualization level B to execute the application program (steps S14, S15).

It is to be noted that this also applies to the electronic apparatus 700. At the time of the execution of the application program, the apparatus executes the VMC having a virtualization level C by a virtual machine (VM-C) 710 having the virtualization level C. Accordingly, the CPU 720 executes the machine code converted from the VMC having the virtualization level C to execute the application program.

As described above, according to the present embodiment, there is provided a mechanism for converting the virtual machine code having a virtualization level which has a relatively high degree of abstraction into the virtual machine code whose degree of abstraction is relatively low, instead of immediately converting the virtual machine code into a machine code of a real machine. Accordingly, the high-rank home server 500 constituting the home network stores the virtual machine code having the virtualization level which has a relatively high degree of abstraction, and converts the code into the machine code at the time of the execution of the application program. Therefore, the code is converted into the code having a final machine level in accordance with the resource to which the application program is allocated in a stage in which the program actually operates, and accordingly relatively dense optimization can be realized.

In short, various virtualization levels can be defined as the virtualization levels, and the application program can be held at a virtualization level which is suitable for circulation or distribution of the application program through the network, loading onto a memory, execution, primary storage and the like. Accordingly, the optimization of the application program is flexibly applied, and the conversion cost of the program can be reduced.

Moreover, the home server 500 or the respective electronic apparatuses 600, 700 may also include a mechanism for rewriting the virtual machine code having an original or intermediate level based on profile information or the like at the time of the execution of the program.

Furthermore, information such as the reservation of the resource which is the environment for operating the program, allocation, topology on the network, and cooperation environment is abstracted, and packaged together with the virtual machine code. Accordingly, a program for performing real-time processing including many restrictions or distributed data processing can be circulated.

Additional advantages and modifications will readily occur to those skilled in the art. Therefore, the invention in its broader aspects is not limited to the specific details and representative embodiments the specific details and representative embodiments shown and described herein. Accordingly, various modifications may be made without departing from the spirit or scope of the general invention concept as defined by the appended claims and their equivalents.

1. A computer system comprising:
a first storage unit to store virtual machine description which defines an architecture of a virtual machine;
a generating unit to generate a virtual machine code from a program which is an execution object;
a second storage unit to store software constituted of the virtual machine code to which the virtual machine description has been added; and
a management unit which takes the software from the second storage unit to execute the software, when the program is executed.

2. The computer system according to claim 1, wherein the management unit includes a compiler which manages the software as package software and which converts the package software into an execution format program of a microprocessor, when the program is executed by the microprocessor.

3. The computer system according to claim 1, wherein the virtual machine is software which does not depend on a platform of a computer.

4. The computer system according to claim 1, wherein the generating unit generates the virtual machine code by use of target machine description which defines the architecture of a designated microprocessor.

5. The computer system according to claim 1, wherein the generating unit includes a reverse compiler which executes reverse compilation to generate the virtual machine code from an assembly code generated based on the architecture of a designated microprocessor.

6. The computer system according to claim 1, wherein the management unit includes a compiler which converts the software into a machine code having an execution format to be executed by a designated microprocessor.

7. The computer system according to claim 1, wherein the first storage unit stores the virtual machine description corresponding to virtual machines corresponding to different virtualization levels.

8. A computer system comprising:
a unit which acquires a virtual machine code generated based on an architecture of a designated microprocessor;
a generating unit to generate package software in which virtual machine description defining architectures of virtual machines having different virtualization levels is combined with the virtual machine code; and
a unit which supplies the package software corresponding to the virtualization level to a system including a virtual machine having a designated virtualization level.

9. The computer system according to claim 8, further comprising:
a unit which converts the package software into a machine code corresponding to the architecture of the designated microprocessor by a compiler.

10. A method of managing software for a computer system using a virtual machine, the method comprising:
generating a virtual machine code from a designated program; and
storing software in which virtual machine description defining an architecture of a virtual machine has been added to the virtual machine code into a storage unit.

11. The method according to claim 10, wherein the generating of the virtual machine code comprises: using target machine description which defines the architecture of a designated microprocessor.

12. The method according to claim 10, wherein the generating of the virtual machine code comprises: executing reverse compilation from an assembly code generated based on the architecture of a designated microprocessor to generate the virtual machine code.

13. The method according to claim 10, wherein the software includes a program having a format which is convertible into a machine code corresponding to the architecture of a designated microprocessor by a designated compiler.
